(19) United States
(12) Patent Application Publication
(10) Pub. No.: US 2018/0061372 A1
(43) Pub. Date: Mar. 1, 2018

(54) DISPLAY APPARATUS, DISPLAY SYSTEM, AND CONTROL METHOD FOR DISPLAY APPARATUS

(71) Applicant: SEIKO EPSON CORPORATION, Tokyo (JP)

(72) Inventor: Takahiro ANO, Matsumoto-shi (JP)

(73) Assignee: SEIKO EPSON CORPORATION, Tokyo (JP)

(21) Appl. No.: 15/685,099

(22) Filed: Aug. 24, 2017

(30) Foreign Application Priority Data
Aug. 31, 2016 (JP) 2016-169064

(51) Int. Cl. G09G 5/32; G09G 5/10; G06F 3/14

(52) U.S. Cl. CPC G09G 5/32; G09G 5/10; G09G 2356/00; G09G 2370/22; G06F 3/1423

(57) ABSTRACT

A projector includes a display unit configured to display an image on a movably supported display surface, a distance sensor configured to detect the distance from a reference position set in advance to the display surface, a storing unit configured to store information indicating processing executed by the display unit when the distance from the reference position to the display surface is a first distance, and a control unit configured to cause the display unit to execute the processing when the distance detected by the distance sensor changes from a second distance to the first distance.

### CROSS-REFERENCE

The entire disclosure of Japanese Patent Application No. 2016-169064, filed Aug. 31, 2016 is expressly incorporated by reference herein.

### BACKGROUND

### 1. Technical Field

The present invention relates to a display apparatus, a display system, and a control method for the display apparatus.

### 2. Related Art

As a system that causes a display apparatus to display an image on a display surface, there has been known a system capable of changing the position of the display surface (see, for example, JP-T-2009-506353 (Patent Literature 1)).

Patent Literature 1 discloses a display system in which a display surface and a projector for projecting an image on the display surface are capable of moving in the vertical direction.

Incidentally, when the position of the display surface is movable, it is sometimes desirable to change the display on the display surface according to the position of the display surface. However, it is troublesome to perform work for operating the display apparatus and changing the display on the display surface every time the position of the display surface is changed. Therefore, there has been a demand for a method of changing the display on the display surface to display corresponding to the position of the display surface after the change as easy as possible.

### SUMMARY

An advantage of some aspects of the invention is to make it possible to, when the position of a display surface is changed, easily change display on the display surface to display corresponding to the position of the display surface.

An aspect of the invention is directed to a display apparatus including: a display unit configured to display an image on a display surface supported movably; a detecting unit configured to detect a distance from a reference position set in advance to the display surface; a storing unit configured to store information indicating processing executed by the display unit when the distance from the reference position to the display surface is a first distance; and a control unit configured to cause the display unit to execute the processing in a case that the distance detected by the detecting unit changes from a second distance to the first distance.

According to the aspect of the invention, when the distance detected by the detecting unit changes to the first distance, it is possible to cause the display unit to execute the processing stored by the storing unit. For example, the storing unit stores, as the processing executed by the display unit when the distance from the reference position to the display surface is the first distance, processing for changing display on the display surface to display corresponding to the first distance. In this case, it is possible to easily change the display on the display surface to the display corresponding to the first distance.

In the display apparatus according to the aspect of the invention, in the case that the distance detected by the detecting unit changes from the second distance to the first distance, the control unit may change a display form of the image displayed on the display surface by the display unit to a display form corresponding to the first distance.

According to the aspect of the invention with this configuration, when the detected distance changes to the first distance, the display form of the display surface is changed to the display form corresponding to the first distance. Therefore, it is possible to change the display form of the display surface to a display form corresponding to the position of the display surface.

In the display apparatus according to the aspect of the invention, the display surface may be supported by a supporting body to be capable of moving in a first direction and a second direction opposite to the first direction, the display apparatus may be fixed to the supporting body such that the distance to the display surface is constant even if the display surface is moved in the first direction or the second direction, and the detecting unit may set, as the reference position, a setting surface on which the supporting body is set, measure a distance from the setting surface to the display apparatus, and detect a distance from the setting surface to the display surface on the basis of the measured distance.

According to the aspect of the invention with this configuration, it is possible to detect the distance from the setting surface, which is the reference position, to the display surface with the detecting unit mounted on the display apparatus.

In the display apparatus according to the aspect of the invention, the storing unit may store, in association with a plurality of sections set in advance by dividing a movable range of the display surface, information indicating a plurality of kinds of processing executed by the display unit, and the control unit may specify a section in which the display surface is located referring to the storing unit on the basis of the distance detected by the detecting unit and cause the display unit to execute processing associated with the specified section.

According to the aspect of the invention with this configuration, it is possible to divide the position of the display surface into sections and execute different processing for each of the sections with the display unit.

In the display apparatus according to the aspect of the invention, the display apparatus may further include a receiving unit configured to receive an input, and the control unit may cause the storing unit to store the information indicating the kinds of processing in association with the sections on the basis of the input received by the receiving unit.

According to the aspect of the invention with this configuration, the processing is associated with the sections and stored in the storing unit according to the input received by the receiving unit. Therefore, it is possible to set, with the receiving unit, the processing associated with the sections.

In the display apparatus according to the aspect of the invention, when determining that a state in which the distance detected by the detecting unit does not change continues, the control unit may specify a section in which the display surface is located and cause the display unit to execute processing associated with the specified section.

According to the aspect of the invention with this configuration, when the state in which the distance detected by the detecting unit does not change continues, it is possible to cause the display unit to execute the processing stored by the storing unit. Therefore, while a change occurs in the distance detected by the detecting unit, it is possible to prevent the display unit from executing the processing and prevent the display by the display unit from frequently changing.

In the display apparatus according to the aspect of the invention, when the distance detected by the detecting unit is equal to or larger than a first threshold, the control unit may set luminance of an image displayed on the display surface by the display unit higher than luminance of an image displayed on the display surface by the display unit when the distance is smaller than the first threshold.

According to the aspect of the invention with this configuration, when the distance detected by the detecting unit is equal to or larger than the first threshold, the luminance of the image displayed on the display surface is set higher than the luminance of the image displayed on the display surface by the display unit when the distance is smaller than the first threshold. When the display surface is disposed near a room light and the contrast of an image displayed on the display surface decreases, it is possible to suppress the decrease in the contrast of the image by setting the luminance of the image displayed on the display surface high.

In the display apparatus according to the aspect of the invention, when the distance detected by the detecting unit is equal to or larger than a second threshold, the control unit may set display on the display surface of an image for operation used for operation of the display apparatus to be hidden.

According to the aspect of the invention with this configuration, when the distance detected by the detecting unit is equal to or larger than the second threshold, it is possible to prevent the image for operation from being displayed on the display surface. Therefore, in a scene in which the position of the display surface is high and it is less likely that the image for operation is used, it is possible to hide the image for operation.

Another aspect of the invention is directed to a display system including: a display apparatus configured to display an image on a display surface supported movably; a detecting unit configured to detect a distance from a reference position set in advance to the display surface; a storing unit configured to store information indicating processing executed by the display apparatus when the distance from the reference position to the display surface is a first distance; and a control unit configured to cause the display apparatus to execute the processing in a case that the distance detected by the detecting unit changes from a second distance to the first distance.

According to the aspect of the invention, when the distance detected by the detecting unit changes to the first distance, it is possible to cause the display apparatus to execute the processing stored by the storing unit. For example, the storing unit stores, as the processing executed by the display unit when the distance from the reference position to the display surface is the first distance, processing for changing display on the display surface to display corresponding to the first distance. In this case, it is possible to easily change the display on the display surface to the display corresponding to the first distance.

Still another aspect of the invention is directed to a control method for a display apparatus that displays an image on a display surface supported movably, the control method including: detecting a distance from a reference position set in advance to the display surface; and executing, in a case that the detected distance changes from a second distance to a first distance, processing corresponding to the first distance.

According to the aspect of the invention, when the detected distance changes to the first distance, it is possible to execute the processing corresponding to the first distance. For example, as the processing executed when the distance from the reference position to the display surface is the first distance, processing for changing display on the display surface to display corresponding to the first distance is stored. In this case, it is possible to easily change the display on the display surface to the display corresponding to the first distance.

### BRIEF DESCRIPTION OF THE DRAWINGS

The invention will be described with reference to the accompanying drawings, wherein like numbers reference like elements.

FIG. 1 is a configuration diagram showing a system configuration of a display system in a first embodiment.

FIG. 2 is a configuration diagram showing the configuration of a projector.

FIG. 3 is a flowchart for explaining the operation of the projector.

FIG. 4 is a diagram showing a processing association table.

FIG. 5 is a flowchart for explaining the operation of the projector.

FIG. 6 is a configuration diagram showing a system configuration of a display system in a second embodiment.

### DESCRIPTION OF EXEMPLARY EMBODIMENTS

Embodiments of the invention are explained below with reference to the accompanying drawings.

### First Embodiment

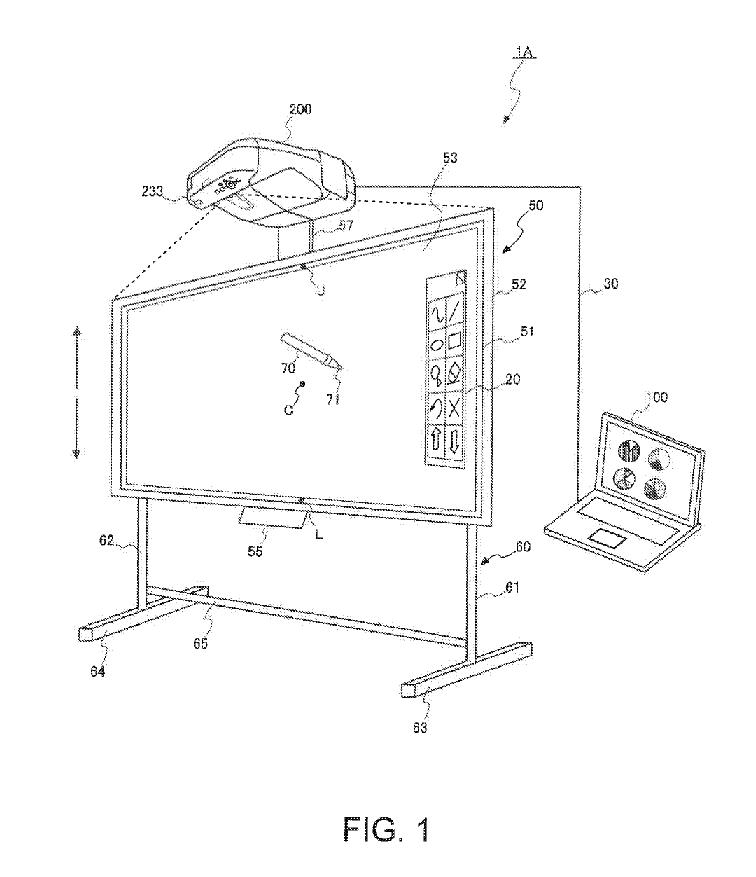

FIG. 1 is a configuration diagram showing a system configuration of a display system 1A.

The display system 1A includes a screen board 50, an image supply apparatus 100, and a projector 200.

The projector 200 causes the screen board 50 to display an image based on an image signal supplied from the image supply apparatus 100. The projector 200 detects operation of a pointer 70 on the screen board 50 and causes the screen board 50 to display an image corresponding to the detected operation. For example, a user draws an object such as a character, a picture, or a sign on the screen board 50 while bringing a tip portion 71 of the pointer 70 into contact with the screen board 50.

The projector 200 causes the screen board 50 to display a tool image 20 selectable by the pointer 70. In the tool image 20, a plurality of icons such as an icon for selecting a line width of an image drawn by the pointer 70 and an icon for erasing an image displayed on the screen board 50. The tool image 20 is equivalent to the “image for operation” of in the aspect of the invention.

The screen board 50 includes a display surface 51 and a supporting stand 60. The supporting stand 60 is equivalent to the “supporting body” in the aspect of the invention. The display surface 51 has a function of a screen capable of displaying an image projected by the projector 200. A region on the display surface 51 on which the image is projected by the projector 200 is referred to as display region 53. The image displayed on the display surface 51 is referred to as projected image. The projector 200 is capable of projecting the projected image using the entire display surface 51 as the display region 53. The projector 200 is capable of projecting the projected image using a part of the display surface 51 as the display region 53.

The display surface 51 is housed in an outer frame 52, which is a rectangular frame body. The outer frame 52 is supported by the supporting stand 60 that supports the display surface 51 to be capable of moving up and down. For example, the outer frame 52 is held by a holding frame (not shown in the figure) and the holding frame is slidably fit in a guiderail (not shown in the figure) provided in the supporting stand 60, whereby the display surface 51 and the outer frame 52 are capable of moving up and down in the vertical direction with respect to the supporting stand 60. The supporting stand 60 includes a pair of columns 61 and 62, leg members 63 and 64 placed on a floor surface to erect the columns 61 and 62, and a coupling member 65 disposed between the columns 61 and 62.

The screen board 50 includes a lock mechanism that fixes the holding frame in a constant position of the guiderail of the supporting stand 60. The user grips a handle 55 shown in FIG. 1 and pulls the handle 55 forward, whereby the lock mechanism is unlocked and the display surface 51 and the outer frame 52 become capable of moving up and down with respect to the supporting stand 60. The user pushes back the handle 55 pulled forward to the original position, whereby the holding frame is locked to the guiderail by the lock mechanism and the display surface 51 and the outer frame 52 are fixed in constant positions. Note that the “forward” refers to the side of the display surface 51 on which the projected image is projected by the projector 200.

The screen board 50 includes a supporting arm 57 capable of fixing the projector 200. One end portion of the supporting arm 57 is fixed to the holding frame. The projector 200 is fixed to the other end portion. The projector 200 is fixed to the supporting arm 57 to be located in front of the display surface 51 and project the projected image toward the display surface 51 side.

The distance between the projector 200 supported by the supporting arm 57 and the display surface 51 is fixed to a constant distance. That is, the length of the supporting arm 57 in the vertical direction or a direction parallel to the display surface 51 cannot be changed. The distance between the projector 200 and the display surface 51 in the vertical direction or the direction parallel to the display surface 51 is maintained at a constant distance.

A distance sensor 235 is disposed on the upper surface of an exterior housing of the projector 200. The distance sensor 235 measures the distance from the floor surface (a reference position), which is a setting surface of the screen board 50, to the distance sensor 235. The upper surface of the exterior housing refers to a surface on which the projector 200 fixed to the screen board 50 is disposed downward in the vertical direction. In this embodiment, the projector 200 is fixed to the screen board 50 and projects the projected image toward the display surface 51 of the screen board 50 located below the projector 200 in the vertical direction. Therefore, the upper surface of the exterior housing is disposed downward in the vertical direction during the use of the projector 200. The distance sensor 235 is equivalent to the “detecting unit” in the aspect of the invention.

In this embodiment, when the display surface 51 moves up or down according to operation by the user, the projector 200 and the distance sensor 235 mounted on the projector 200 also move up or down together with the display surface 51. That is, in this embodiment, the display surface 51, the outer frame 52, the holding frame, the supporting arm 57, the projector 200, and the distance sensor 235 move in the up-down direction by the same distance according to the operation of the handle 55.

The distance sensor 235 includes, for example, a light source such as an LED or a laser diode and a light receiving unit that receives reflected light of light emitted by the light source and reflected by a measurement target. The distance sensor 235 performs distance measurement on the basis of the principle of triangulation and a time difference and outputs distance information.

The distance sensor 235 may include a sound source that emits ultrasound and a detecting unit that receives the ultrasound reflected by a measurement target. In this case, the distance sensor 235 performs distance measurement on the basis of a time difference between transmission and reception of the ultrasound and outputs distance information.

A stereo camera is used as the distance sensor 235. The distance sensor 235 performs distance measurement on a set of stereo image pairs, which are picked up by the stereo camera, from a positional deviation amount of positions corresponding to the stereo image pairs according to the principle of triangulation and outputs distance information.

The distance between the reference position and the projector 200 may be measured by an image pickup unit 241 provided in a pointer detecting unit 240 rather than separately providing the distance sensor 235. For example, it is also possible that a marker prepared in advance is placed on the floor surface serving as the reference position, an image of the marker is picked up by the image pickup unit 241, and a distance is calculated on the basis of a size of the marker shown in the picked-up image.

The projector 200 changes, on the basis of the distance information input from the distance sensor 235, a display form of the projected image projected on the display surface 51. Details of this processing are explained below.

The projector 200 is connected to the image supply apparatus 100 by a cable 30. The projector 200 processes an image signal transmitted from the image supply apparatus 100 and projects a still image or a moving image on the display surface 51. In this embodiment, the projector 200 and the image supply apparatus 100 are connected by the wired cable 30. However, the projector 200 and the image supply apparatus 100 can also be connected by wireless communication.

As the image supply apparatus 100, for example, a notebook PC (Personal Computer), a desktop PC, a tablet terminal, a smartphone, and a PDA (Personal Digital Assistant) can be used. As the image supply apparatus 100, a video reproducing apparatus, a DVD (Digital Versatile Disk) player, a Blu-ray disk player, a television tuner apparatus, a set top box of a CATV (Cable Television), a video game machine, and the like may be used.

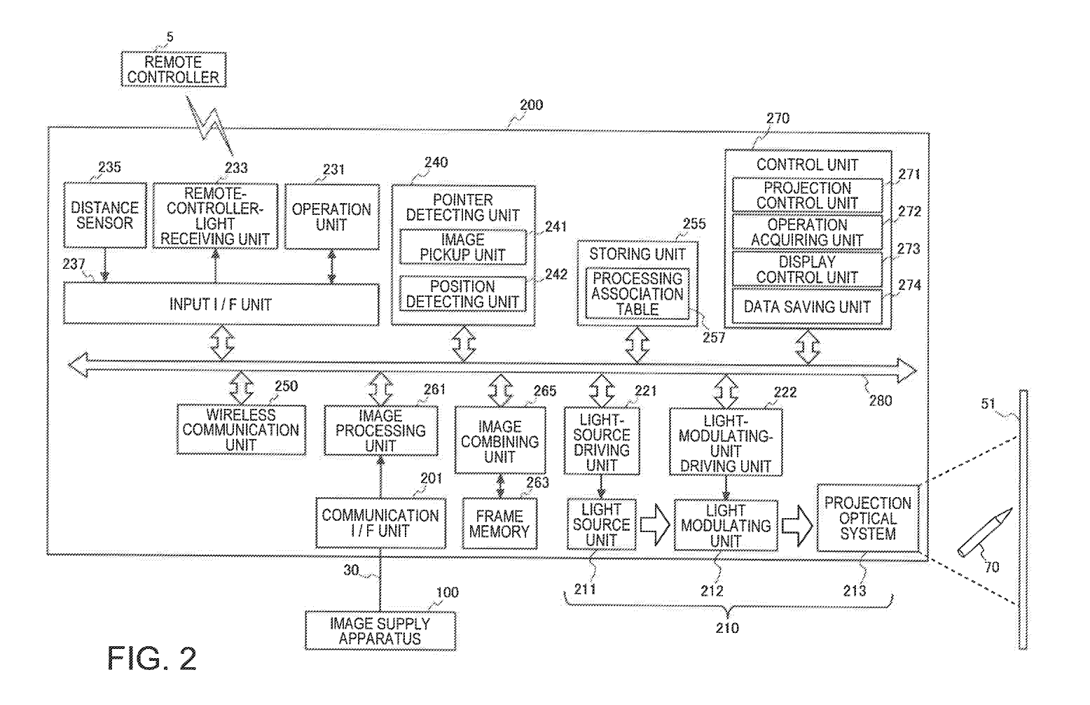

FIG. 2 is a configuration diagram of the projector 200. The projector 200 includes a communication interface (I/F) unit 201. In the following explanation, an interface is abbreviated as I/F. The communication I/F unit 201 includes a connector connected to the cable 30 and an I/F circuit (both of which are not shown in the figure). The communication I/F unit 201 receives an image signal transmitted from the image supply apparatus 100 connected to the cable 30. The communication I/F unit 201 demodulates the received image signal, extracts image data, and outputs the extracted image data to an image processing unit 261. The image data may be moving image data or may be still image data.

The communication I/F unit 201 may be an interface for communication such as Ethernet (registered trademark), IEEE1394, USB, or RS-232C. The communication I/F unit 201 may be an interface for image data such as MHL (registered trademark), HDMI (registered trademark), or Display Port. The communication I/F unit 201 may include an A/D conversion circuit that, when an analog image signal is input from the image supply apparatus 100, converts the analog image signal into digital data.

The projector 200 includes a display unit 210 that forms an optical image and projects the image on the display surface 51.

The display unit 210 includes a light source unit 211, a light modulating unit 212, and a projection optical system 213.

The light source unit 211 includes a light source including a xenon lamp, an ultra-high pressure mercury lamp, an LED (Light Emitting Diode), or a laser light source. The light source unit 211 may include a reflector and an auxiliary reflector that guide light emitted by the light source to the light modulating unit 212. The light source unit 211 may include a lens group for improving an optical characteristic of projected light, a sheet polarizer, or a dimming element for reducing a light amount of the light emitted by the light source on a rout leading to the light modulating unit 212 (all of which are not shown in the figure).

The light source unit 211 is driven by a light-source driving unit 221. The light-source driving unit 221 is connected to an internal bus 280 and lights and extinguishes the light source of the light source unit 211 according to control by a control unit 270 also connected to the internal bus 280.

The light modulating unit 212 includes, for example, three liquid crystal panels corresponding to the three primary colors of RGB. Light emitted by the light source unit 211 is separated into color lights of the three colors of RGB. The color lights are respectively made incident on the liquid crystal panels corresponding to the color lights. The three liquid crystal panels are transmissive liquid crystal panels. The three liquid crystal panels modulate lights transmitted through the liquid crystal panels and generate image lights. The image lights transmitted through the liquid crystal panels and modulated are combined by a combination optical system such as a cross dichroic prism and emitted to the projection optical system 213.

The light modulating unit 212 is driven by a light-modulating-unit driving unit 222. The light-modulating-unit driving unit 222 is connected to the internal bus 280.

Projected image data corresponding to the primary colors of RGB are input to the light-modulating-unit driving unit 222 from an image combining unit 265. The light-modulating-unit driving unit 222 converts the input projected image data into data signals suitable for the operation of the liquid crystal panels. The light-modulating-unit driving unit 222 applies voltages to pixels of the liquid crystal panels on the basis of the converted data signals and draws images on the liquid crystal panels.

The projection optical system 213 includes a lens group that projects the image lights modulated by the light modulating unit 212 on the display surface 51 and forms an image on the display surface 51. The projection optical system 213 may include a zoom mechanism that enlarges or reduces the image projected on the display surface 51 and a focus adjusting mechanism that performs adjustment of a focus.

The projector 200 includes an operation unit 231, a remote-controller-light receiving unit 233, a distance sensor 235, and an input I/F unit 237. The operation unit 231, the remote-controller-light receiving unit 233, and the distance sensor 235 are connected to the input I/F unit 237. The input I/F unit 237 is connected to the internal bus 280. The operation unit 231 is equivalent to the “receiving unit” in the aspect of the invention.

Various operation keys for operating the projector 200 are provided in the operation unit 231. For example, a power key for instructing power-on or power-off of the projector 200 and a menu key for displaying the tool image 20 for performing various kinds of setting are provided in the operation unit 231. When an operation key is operated, the input I/F unit 237 outputs an operation signal corresponding to the operated key to the control unit 270.

The projector 200 includes a remote controller 5 used by the user. The remote controller 5 is equivalent to the “receiving unit” in the aspect of the invention. The remote controller 5 includes various buttons and transmits infrared signals according to operation of the buttons.

The remote-controller-light receiving unit 233 receives an infrared signal transmitted from the remote controller 5. The input I/F unit 237 decodes the infrared signal received by the remote-controller-light receiving unit 233, generates an operation signal indicating operation content in the remote controller 5, and outputs the operation signal to the control unit 270.

The distance sensor 235 measures the distance from the floor surface, which is the setting surface on which the supporting stand 60 of the screen board 50 is disposed, to the distance sensor 235 and outputs distance information, which is a measurement result, to the input I/F unit 237. The input I/F unit 237 A/D-converts the distance information measured by the distance sensor 235 and outputs the distance information to the control unit 270.

The distance sensor 235 measures the distance in every fixed time and outputs obtained distance information to the input I/F unit 237. When an instruction is input to the distance sensor 235 from the control unit 270, the distance sensor 235 measures the distance and outputs obtained distance information to the input I/F unit 237.

The projector 200 includes a pointer detecting unit 240. The pointer detecting unit 240 is connected to the internal bus 280 and operates according to the control by the control unit 270. The pointer detecting unit 240 includes an image pickup unit 241 and a position detecting unit 242 and detects operation by the pointer 70 on the display surface 51.

The configuration of the pointer 70 is explained.

The pointer 70 of a pen type functions as a pointing device. The pointer 70 is used when the user operates the tool image 20 projected on the display surface 51 by the projector 200 and when the user uses a whiteboard function.

An operation switch (not shown in the figure) that emits infrared light when being pressed is incorporated in the tip portion 71 of the pointer 70. The user holds the pointer 70 in a hand and operates the pointer 70 to bring the tip portion 71 of the pointer 70 into contact with the display surface 51. When operation for pressing the tip portion 71 of the pointer 70 against a wall or the display surface 51 is performed, the operation switch is turned on and infrared light is emitted.

The image pickup unit 241 includes an image pickup device such as a CMOS that receives the infrared light emitted by the tip portion 71 of the pointer 70, an optical system that forms an image on the image pickup device, and a diaphragm that limits light made incident on the image pickup element. An image pickup direction and an image pickup range (an angle of view) of the image pickup unit 241 are directed to a direction same as or substantially the same as the direction of the projection optical system 213. The image pickup direction and the image pickup range cover a range in which the projection optical system 213 projects an image on the display surface 51.

The image pickup unit 241 sets a range including the display surface 51 as the image pickup range and outputs picked-up image data obtained by picking up an image of the image pickup range to the position detecting unit 242.

The position detecting unit 242 detects operation and an operation position of the pointer 70. The position detecting unit 242 detects light emission of the tip portion 71 of the pointer 70 from the picked-up image data picked up by the infrared light and detects the position of the tip portion 71 of the pointer 70. The position detecting unit 242 generates coordinate information indicating the detected position of the tip portion 71 of the pointer 70 and outputs the coordinate information to the control unit 270 as coordinate information indicating the operation position of the pointer 70. The coordinate information is a coordinate on the picked-up image data picked up by the image pickup unit 241.

Note that, in this embodiment, the pointer 70 of the pen type is explained as an example of the pointer 70. However, a finger of the user can also be used as a pointer. In this case, the position detecting unit 242 detects the finger of the user from the picked-up image data of the image pickup unit 241 and outputs a tip portion of the detected finger to the control unit 270 as coordinate information indicating an operation position.

The projector 200 includes a wireless communication unit 250. The wireless communication unit 250 is connected to the internal bus 280 and operates according to the control by the control unit 270.

The wireless communication unit 250 includes an antenna and an RF (Radio Frequency) circuit not shown in the figure. The wireless communication unit 250 executes wireless communication with an external apparatus under the control by the control unit 270. As a wireless communication scheme of the wireless communication unit 250, a short-range wireless communication scheme such as a wireless LAN (Local Area Network), a Bluetooth (registered trademark), a UWB (Ultra Wide Band), or infrared communication can be adopted. As the wireless communication scheme of the wireless communication unit 250, a wireless communication scheme that makes use of a cellular phone line can be adopted.

The projector 200 includes an image processing system. The image processing system is configured mainly from the control unit 270 that comprehensively controls the entire projector 200. Besides, the image processing system includes a storing unit 255, the image processing unit 261, an image combining unit 265, and a frame memory 263. The units configuring the image processing system are connected to one another by the internal bus 280 to be capable of performing data communication.

The image processing unit 261 develops image data input from the communication I/F unit 201 in the frame memory 263 and processes the image data. The processing performed by the image processing unit 261 includes, for example, resolution conversion (scaling) processing or resize processing, shape correction processing such as distortion correction, digital zoom processing, tone correction processing, and luminance correction processing. The image processing unit 261 executes processing designated by the control unit 270 and, according to necessity, performs processing using parameters input from the control unit 270. Naturally, the image processing unit 261 is capable of performing a plurality of kinds of processing in combination among the kinds of processing explained above. The image processing unit 261 outputs the image data, for which the processing is finished, to the image combining unit 265.

The image data processed by the image processing unit 261 also includes image data stored in the storing unit 255 beforehand.

The image combining unit 265 develops the image data input from the image processing unit 261 in the frame memory 263. When drawing data is input from the control unit 270, the image combining unit 265 superimposes the acquired drawing data on the image data developed in the frame memory 263 and generates projected image data according to the control by the control unit 270. Details of the drawing data are explained below. The image combining unit 265 reads out the generated projected image data from the frame memory 263 and outputs the projected image data to the light-modulating-unit driving unit 222. When drawing data is not input from the control unit 270, the image combining unit 265 reads out the image data processed by the image processing unit 261 and developed in the frame memory 263 and outputs the read-out data to the light-modulating-unit driving unit 222 as the projected image data.

The storing unit 255 is an auxiliary storage device such as a hard disk device. The storing unit 255 may be replaced with a flash memory capable of storing a large volume of information or an optical disk such as a CD (Compact Disc), a DVD (Digital Versatile Disc), or a BD (Blu-ray (registered trademark) Disc). The storing unit 255 stores application programs executed by the control unit 270 and various data.

The storing unit 255 stores a processing association table 257. The processing association table 257 is a table in which a movable range of the display surface 51 is divided into a plurality of sections and information indicating ranges of the divided sections and processing executed by the projector 200 in the sections are registered in association with each other. Details of the processing association table 257 are explained below.

The control unit 270 includes, as hardware, a CPU and storage devices such as a ROM and a RAM (all of which are not shown in the figure). The ROM is a nonvolatile storage device such as a flash ROM and stores a control program and data. The RAM configures a work area of the CPU. The CPU develops the control program read out from the ROM in the RAM, executes the developed control program, and controls the units of the projector 200.

The control unit 270 includes, as functional blocks, a projection control unit 271, an operation acquiring unit 272, a display control unit 273, and a data saving unit 274. The functional blocks are realized by executing the control program developed in the RAM.

The projection control unit 271 controls the units of the projector 200 to display a projected image on the display surface 51.

Specifically, the projection control unit 271 causes the image processing unit 261 to process image data received by the communication I/F unit 201. In this case, the projection control unit 271 may read out parameters necessary for the processing by the image processing unit 261 from the storing unit 255 and output the parameters to the image processing unit 261.

The projection control unit 271 controls the image combining unit 265 to execute processing for combining image data and drawing data. The projection control unit 271 controls the light-modulating-unit driving unit 222 to draw images on the liquid crystal panels of the light modulating unit 212. Further, the projection control unit 271 controls the light-source driving unit 221 to light the light source of the light source unit 211 and adjust the luminance of the light source. Consequently, the light source emits light and image light modulated by the light modulating unit 212 is projected on the display surface 51 by the projection optical system 213.

The operation acquiring unit 272 converts a coordinate indicated by coordinate information input from the pointer detecting unit 240. The coordinate information output to the control unit 270 by the pointer detecting unit 240 is a coordinate on picked-up image data generated by the image pickup unit 241. The operation acquiring unit 272 converts the coordinate indicated by the coordinate information input from the pointer detecting unit 240 into a coordinate on the frame memory 263. That is, the operation acquiring unit 272 converts the coordinate input from the pointer detecting unit 240 into a coordinate on the frame memory 263, which is a coordinate for the image combining unit 265 to perform drawing in the frame memory 263. The operation acquiring unit 272 outputs the coordinate information of the converted coordinate to the display control unit 273.

The display control unit 273 joins coordinates of operation positions indicated by the coordinate information input from the operation acquiring unit 272 and detects a track of operation by the pointer 70. The display control unit 273 generates drawing data according to the detected track. The drawing data is data representing, for example, a character, a sign, a line, or a figure. The display control unit 273 outputs the generated drawing data to the image combining unit 265.

When the coordinate indicated by the coordinate information input from the operation acquiring unit 272 indicates the same position or substantially the same position continuously for a plurality of times, the display control unit 273 determines that operation for selecting a detected operation position is input. In this case, for example, when the selected operation position is a position where the tool image 20 is displayed, the display control unit 273 determines that the operation is operation for selecting an icon of the tool image 20 displayed on the display surface 51. The display control unit 273 receives the operation as operation for selecting an icon displayed in the detected operation position.

Distance information measured by the distance sensor 235 is input to the display control unit 273. The display control unit 273 detects the height of the display surface 51 on the basis of the input distance information.

The storing unit 255 stores, in advance, information indicating the distance between the display surface 51 and the distance sensor 235 (hereinafter referred to as subtraction distance). The distance between the display surface 51 and the distance sensor 235 is always constant. Therefore, the display control unit 273 subtracts the subtraction distance from the distance indicated by the distance information measured by the distance sensor 235 to calculate the height from the floor surface to the display surface 51.

In this embodiment, the display control unit 273 calculates, for example, the distance from a center position C of the display surface 51 to the floor surface as the height of the display surface 51. At this point, the subtraction distance stored by the storing unit 255 is the distance from the center position of the display surface 51 to the distance sensor 235.

The height of the display surface 51 calculated by the display control unit 273 is not limited to the height to the center position of the display surface 51 and may be the height to a lower end portion L in the vertical direction of the display surface 51 or may be the height to an upper end portion U in the vertical direction of the display surface 51.

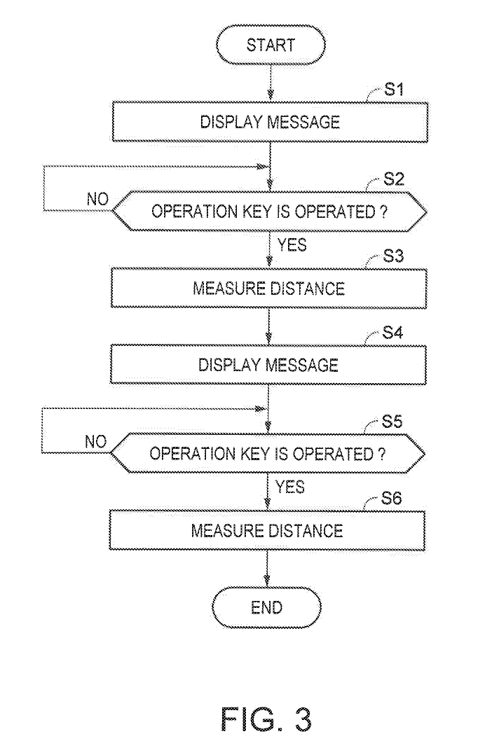

When detecting the height of the display surface 51, the display control unit 273 determines whether there is a change in the detected height of the display surface 51. When there is a change in the height of the display surface 51, the display control unit 273 changes a display form of the display surface 51 to a display form corresponding to the height of the display surface 51. Details of the operation of the display control unit 273 are explained with reference to FIGS. 3 to 5.

When the pointer 70 or the operation unit 231 is operated and the data saving unit 274 receives an instruction to save data, the data saving unit 274 acquires the projected image data developed in the frame memory 263 and causes the storing unit 255 to store the acquired projected image data.

The operation of the display control unit 273 is explained.

FIG. 3 is a flowchart for explaining detection processing for a movable range executed according to the control by the display control unit 273.

The detection processing for a movable range is processing for moving the display surface 51 up and down and recording, as distance information, distances measured by the distance sensor 235 when the display surface 51 is present in a highest position and when the display surface 51 is present in a lowest position. The processing may be executed immediately after the power supply is turned on and the projector 200 starts or may be executed when an operation key of the operation unit 231 or the remote controller 5 is operated.

First, the display control unit 273 generates a message displayed on the display surface 51 and controls the display unit 210 to display the generated message on the display surface 51 (step S1). The message is a message for requesting the user to lower the display surface 51 to the lowest position and a message for requesting the user to depress a predetermined operation key provided in the remote controller 5 after lowering the display surface 51 to the lowest position.

After displaying the message on the display surface 51, the display control unit 273 determines whether the predetermined operation key of the remote controller 5 is operated (step S2). The display control unit 273 determines whether an operation signal corresponding to the predetermined operation key is input from the input I/F unit 237 and determines whether the predetermined operation key of the remote controller 5 is operated. In the case of negative determination (NO in step S2), the display control unit 273 stays on standby until an operation signal is input from the input I/F unit 237.

In the case of affirmative determination (YES in step S2), the display control unit 273 causes the distance sensor 235 to execute distance measurement (step S3).

The distance sensor 235 measures the distance from the floor surface to the distance sensor 235 according to an instruction from the display control unit 273. The distance sensor 235 outputs distance information indicating a measurement result. The distance information output by the distance sensor 235 is input to the control unit 270 via the input I/F unit 237. The display control unit 273 causes the RAM or the storing unit 255 to store the input distance information.

Subsequently, the display control unit 273 generates a message displayed on the display surface 51 and controls the display unit 210 to display the generated message on the display surface 51 (step S4). The message is a message for requesting the user to raise the display surface 51 to the highest position and a message for requesting the user to depress a predetermined operation key provided in the remote controller 5 after raising the display surface 51 to the highest position.

After displaying the message on the display surface 51, the display control unit 273 determines whether the predetermined operation key of the remote controller 5 is operated (step S5). In the case of negative determination (NO in step S5), the display control unit 273 stays on standby until an operation signal is input from the input I/F unit 237.

In the case of affirmative determination (YES in step S5), the display control unit 273 causes the distance sensor 235 to execute distance measurement (step S6). The display control unit 273 causes the RAM or the storing unit 255 to store distance information, which is a measurement result.

Subsequently, the display control unit 273 calculates, on the basis of the distance information measured by the distance sensor 235, height at the time when the display surface 51 is present in the highest position and height at the time when the display surface 51 is present in the lowest position. The display control unit 273 subtracts the subtraction distance stored in the storing unit 255 from the distance information measured by the distance sensor 235 and calculates the height at the time when the display surface 51 is present in the highest position and the height at the time when the display surface 51 is present in the lowest position. In the following explanation, the height at the time when the display surface 51 is present in the highest position is referred to as upper limit value of the movable range and the height at the time when the display surface 51 is present in the lowest position is referred to as lower limit value of the movable range.

When detecting the upper limit value and the lower limit value of the movable range of the display surface 51, the display control unit 273 generates the processing association table 257.

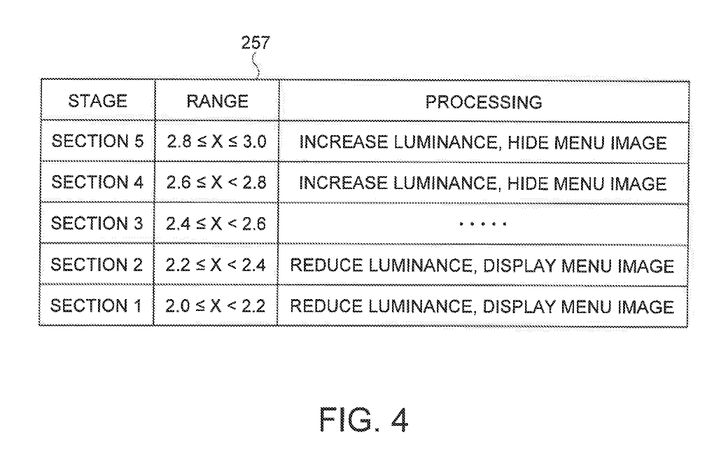

FIG. 4 is a diagram showing the processing association table 257.

The processing association table 257 is a table in which the movable range of the display surface 51 is divided into a plurality of sections for each constant distance and information indicating ranges of the divided sections and kinds of processing executed by the projector 200 in the sections are registered in association with each other. The information indicating the ranges of the divided sections is equivalent to the “first distance” in the aspect of the invention. The number of the divided sections may be a default value set beforehand or the user may set the number by operating the remote controller 5.

In FIG. 4, the processing association table 257 is shown in which it is assumed that the upper limit value of the movable range measured by the distance sensor 235 is 3.0 m, the lower limit value is 2.0 m, and the number of divisions is “5”.

The display control unit 273 divides a movable range of 2.0 m or more and 3.0 m or less into, for example, five sections as indicated by (1) to (5) below. Note that X indicates the height of the display surface 51 calculated on the basis of the distance information measured by the distance sensor 235.

Section 1: 2.6≦X<2.2 (1)

Section 2: 2.2≦X<2.4 (2)

Section 3: 2.4≦X<2.6 (3)

Section 4: 2.6≦X<2.8 (4)

Section 5: 2.8≦X≦3.0 (5)

After dividing the movable range into the plurality of sections, the display control unit 273 associates the kinds of processing executed by the projector 200 with the divided sections.

The kinds of processing associated with the divided sections include, for example, processing for changing the luminance of the light source of the light source unit 211, processing for switching display and hiding of the tool image 20, and processing for adjusting a display position of the tool image 20 displayed on the display surface 51. The kinds of processing associated with the divided sections include, for example, processing for changing the icons displayed in the tool image 20 and processing for switching validity and invalidity of the icons.

When the height of the display surface 51 is high positions such as the section 4 and the section 5, the display control unit 273 associates, with the section 4 and the section 5, processing for changing the luminance of the light source unit 211 to values higher by values set in advance.

When the height of the display surface 51 is low positions such as the section 1 and the section 2, the display control unit 273 associates, with the section 1 and the section 2, kinds of processing for changing the luminance of the light source unit 211 to values lower by values set in advance.

When the height of the display surface 51 increases, the distance between the display surface 51 and a room light such as a fluorescent lamp decreases. When light irradiated from the room light is reflected on the display surface 51, the contrast of an image displayed on the display surface 51 decreases. This influence is more conspicuous as the distance between the display surface 51 and the room light is shorter. Therefore, when the height of the display surface 51 is larger than height set in advance, the display control unit 273 controls the light-source driving unit 221 and changes the luminance of the light source unit 211 to a value higher by a value set in advance. The display control unit 273 may increase the luminance of the light source unit 211 stepwise according to the height of the display surface 51. For example, the display control unit 273 changes the luminance of the light source unit 211 to a value higher by the value set in advance every time the height of the display surface 51 increases to the section 3, the section 4, and the section 5. Consequently, every time a light amount of the room light irradiated on the display surface 51 increases, the luminance of the light source unit 211 can be increased. Therefore, even if the height of the display surface 51 is changed to be larger, it is possible to suppress a decrease in the contrast of the image displayed on the display surface 51.

Note that, for example, when the luminance of the light source unit 211 in the section 5 is set higher than the luminance of the light source unit 211 in the section 4, 2.8 is equivalent to the “first threshold” in the aspect of the invention. Similarly, when the luminance of the light source unit 211 in the section 4 is set higher than the luminance of the light source unit 211 in the section 3, 2.6 is equivalent to the “first threshold” in the aspect of the invention.

When the height of the display surface 51 is a position lower than the height set in advance, the display control unit 273 controls the light-source driving unit 221 to change the luminance of the light source unit 211 to a value lower by a value set in advance. The display control unit 273 may reduce the luminance of the light source unit 211 stepwise according to the height of the display surface 51. For example, the display control unit 273 changes the luminance of the light source unit 211 to a value lower by the value set in advance every time the height of the display surface 51 decreases to the section 3, the section 2, and the section 1. Consequently, it is possible to suppress power consumption.

When the height of the display surface 51 is high positions such as the section 4 and the section 5, the display control unit 273 associates, with the section 4 and the section 5, processing for hiding the tool image 20 displayed on the display surface 51. When the height of the display surface 51 is set to low positions such as the section 2 and the section 1, the display control unit 273 associates, with the section 2 and the section 1, processing for displaying the tool image 20 on the display surface 51.

Operation for changing the position of the display surface 51 to a high position is not performed to perform writing on the display surface 51 but is often performed to enable a person present in a distant place to view the writing on the display surface 51. Therefore, when the position of the display surface 51 is changed to a high position, the display control unit 273 hides the tool image 20 and prevents a problem in that an image on the display surface 51 in a place where the tool image 20 is displayed is hidden by the tool image 20 and invisible.

Operation for changing the position of the display surface 51 to a low position is often performed to perform wiring on the display surface 51. Therefore, when the position of the display surface 51 is changed to a low position, the display control unit 273 displays the tool image 20 on the display surface 51 and enables the user to perform writing on the display surface 51 by operating the pointer 70.

Note that, for example, when the tool image 20 displayed on the display surface 51 is hidden when the height of the display surface 51 is the section 4 or more, 2.6 is equivalent to the “second threshold” in the aspect of the invention.

Even if the height of the display surface 51 is changed, the display control unit 273 may control the display position of the tool image 20 such that the tool image 20 is always displayed in the same position from the floor surface. Even if the height of the display surface 51 is changed, since the tool image 20 is displayed in the same position from the floor surface, it is possible to suppress deterioration in operability in the selection of an icon displayed in the tool image 20.

The display control unit 273 determines the height of the display surface 51 from the floor surface on the basis of a measured value of the distance sensor 235 and calculates, on the basis of a result of the determination, a display position on the display surface 51 where by tool image 20 is displayed.

When the height of the display surface 51 is changed, the display control unit 273 calculates a difference between the heights of the display surface 51 before the change and after the change and changes, according to the calculated difference between the heights, the display position on the display surface 51 where the tool image 20 is displayed. For example, when the height of the display surface 51 is changed to be 20 cm higher, the display control unit 273 controls the display position of the tool image 20 on the display surface 51 to be 20 cm lower than the display position of the display surface 51 before the height of the display surface 51 is changed to be higher.

The display control unit 273 may set the processing association table 257 such that icons of the tool image 20 set in sections in which the display surface 51 is high and icons of the tool image 20 set in sections in which the display surface 51 is low are different.

The display control unit 273 displays the same icons in the tool image 20 irrespective of the heights of the sections. However, the display control unit 273 may set the processing association table 257 to change operable icons according to the sections.

When the height of the display surface 51 is heights where children can operate the display surface 51 such as the section 2 and the section 1, the display control unit 273 sets icons undesirable for the children to operate to be hidden and sets the icons invalid to disable the children to select the icons even if the children select the icons with the pointer 70.

When the height of the display surface 51 is heights where children cannot operate the display surface 51 such as the section 4 and the section 5, the display control unit 273 displays all the icons in the tool image 20. The display control unit 273 sets all the icons displayed in the tool image 20 as valid icons and changes all the icons to an operable state.

Note that, when the display surface 51 is set low, the user may set hidden or invalid icons beforehand by operating the remote controller 5 or the operation unit 231.

The display control unit 273 may automatically set, on the basis of the height of the display surface 51, association of the divided sections and the processing executed by the projector 200. The user may manually set the association by operating the remote controller 5 or the operation unit 231.

The display control unit 273 performs setting of the processing association table 257 and, when distance information of the distance sensor 235 is input, specifies a section to which the height of the display surface 51 detected on the basis of the input distance information belongs, and executes processing associated with the specified section. Consequently, a display form of the display surface 51 is changed according to the height of the display surface 51. The display form includes information such as brightness of the display surface 51, content of displayed information, and a position of the displayed information. Besides, the display form may include a tint, the size of characters, and the like.

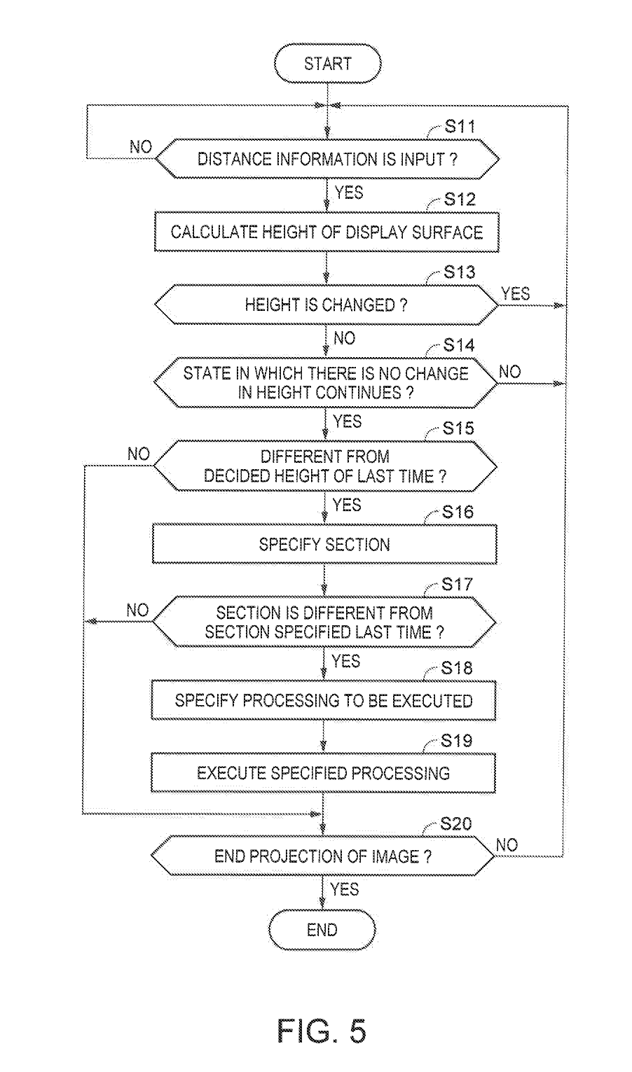

FIG. 5 is a flowchart for explaining the operation of the projector 200. In particular, FIG. 5 is a flowchart for explaining operation after the execution of the detection processing for a movable range shown in FIG. 3.

Distance information measured by the distance sensor 235 at every fixed interval is input to the display control unit 273 (step S11). When there is no input of distance information from the distance sensor 235 (NO in step S11), the display control unit 273 stays on standby until distance information is input. When distance information is input (YES in step S11), the display control unit 273 calculates the height of the display surface 51 on the basis of the input distance information (step S12). After calculating the height of the display surface 51, the display control unit 273 compares the height of the display surface 51 with the height of the display surface 51 calculated on the basis of distance information input last time and determines whether the height of the display surface 51 is changed (step S13). In the case of affirmative determination (YES in step S13), the display control unit 273 returns to step S11 and stays on standby until distance information measured by the distance sensor 235 next is input.

When the determination in step S13 is negative determination (NO in step S13), the display control unit 273 determines whether the number of times the height of the display surface 51 is determined as not being changed continues the number of times set in advance. That is, the display control unit 273 determines whether the height of the display surface is the same height continuously for a constant time or more (step S14). In the case of negative determination (NO in step S14), the display control unit 273 returns to step S11 and stays on standby until distance information measured by the distance sensor 235 next is input.

When the determination in step S14 is affirmative determination (YES in step S14), the display control unit 273 determines that the height of the display surface 51 is decided. In this case, the display control unit 273 determines whether the decided height of the display surface 51 (hereinafter referred to as decided height of this time) and decided height of the last time are different (step S15). The decided height of the last time is the height of the display surface 51 decided as being the same height for the constant time or more last time.

When the determination in step S15 is negative determination (NO in step S15), the display control unit 273 shifts to determination in step S20 and determines whether projection of an image on the display surface 51 ends (step S20). In the case of affirmative determination (YES in step S20), the display control unit 273 ends this processing flow. In the case of negative determination (NO in step S20), the display control unit 273 returns to step S11 and stays on standby until distance information measured by the distance sensor 235 next is input.

When the determination in step S15 is affirmative determination (YES in step S15), the display control unit 273 specifies, referring to the processing association table 257, a section to which the decided height of this time belongs (step S16). After specifying the section, the display control unit 273 determines whether the specified section is different from a section specified last time (step S17). The section specified last time is a section to which the decided height of the last time belongs.

Note that, when the decided height of the last time and the decided height of this time are different and the section to which the decided height of the last time belongs and the section to which the decided height of this time belongs are different, the decided height of last time is equivalent to the “second distance” in the aspect of the invention and the decided height of this time is equivalent to the “first distance” in the aspect of the invention.

When the determination in step S17 is negative determination (NO in step S17), the display control unit 273 determines whether the projection of the image on the display surface 51 ends (step S20). In the case of negative determination (NO in step S20), the display control unit 273 returns to the determination in step S11.

When the determination in step S17 is affirmative determination (YES in step S17), the display control unit 273 specifies, referring to the processing association table 257, processing associated with the specified section (step S18). The display control unit 273 controls the units of the projector 200 and executes processing corresponding to the acquired information (step S19). After executing the processing, the display control unit 273 determines whether the display of the image on the display surface 51 ends (step S20). In the case of negative determination (NO in step S20), the display control unit 273 returns to step S11 and stays on standby until distance information is input from the distance sensor 235. In the case of affirmative determination (YES in step S20), the display control unit 273 ends this processing flow.

As explained above, the embodiment applied with the display apparatus and the control method for the display apparatus according to the invention includes the display unit 210, the distance sensor 235, the storing unit 255, and the control unit 270.

The display unit 210 displays an image on the display surface 51 of the movably supported screen board 50.

The distance sensor 235 detects the distance from the setting surface of the screen board 50, which is the reference position set in advance, to the display surface 51.

When the distance from the setting surface of the screen board 50 to the display surface 51 is the distance set in advance, the storing unit 255 stores the information indicating the processing executed by the display unit 210.

When the distance detected by the distance sensor 235 changes to the first distance, the control unit 270 causes the display unit 210 to execute the processing.

For example, as the processing executed by the projector 200 when the distance from the setting surface to the display surface 51 is the first distance, the processing for changing the display on the display surface 51 to the display corresponding to the first distance is stored. Consequently, it is possible to easily change the display on the display surface 51 to the display corresponding to the distance set in advance.

When the distance detected by the distance sensor 235 is the distance set in advance, the control unit 270 changes the display form of the image displayed on the display surface 51 by the display unit 210 to the display form corresponding to the distance set in advance.

Therefore, it is possible to change the display form of the display surface 51 to the display form corresponding to the distance from the setting surface of the screen board 50 to the display surface 51.

The display surface 51 of the screen board 50 is supported to be capable of moving in the upward direction, which is the first direction, and the downward direction, which is the second direction, by the supporting stand 60.

The projector 200 is fixed to the supporting stand 60 such that the distance to the display surface 51 is constant even if the display surface 51 is moved in the up-down direction.

The distance sensor 235 sets, as the reference position, the setting surface on which the supporting stand 60 is set, measures the distance from the setting surface to the projector 200, and detects the distance from the setting surface to the display surface 51 on the basis of the measured distance.

Therefore, it is possible to detect the distance from the setting surface to the display surface 51 with the distance sensor 235 mounted on the projector 200.

The storing unit 255 stores the information indicating the plurality of kinds of processing executed by the display unit 210 in association with the plurality of sections set in advance by dividing the movable range of the display surface 51.

The control unit 270 specifies a section in which the display surface 51 is located referring to the storing unit 255 on the basis of the distance information measured by the distance sensor 235. The control unit 270 causes the display unit 210 to execute the processing associated with the specified section.

Therefore, it is possible to divide the position of the display surface 51 into sections and execute different processing for each of the sections with the projector 200.

The projector 200 includes the remote controller 5 or the operation unit 231 that receives operation by the user.

The control unit 270 causes, on the basis of an input received by the remote controller 5 or the operation unit 231, the storing unit 255 to store the information indicating the kinds of processing in association with the sections.

Therefore, it is possible to set, with the remote controller 5 or the operation unit 231, kinds of processing associated with the plurality of sections.

When determining that the state in which a change does not occur in the distance indicated by the distance information detected by the distance sensor 235 continues, the control unit 270 specifies a section in which the display surface 51 is located and causes the display unit 210 to execute processing associated with the specified section.

Therefore, while a change occurs in the distance indicated by the distance information detected by the distance sensor 235, it is possible to prevent the display unit 210 from executing the processing and prevent the display by the display unit 210 from frequently changing.

When the distance indicated by the distance information detected by the distance sensor 235 is equal to or larger than the first threshold, the control unit 270 sets the luminance of an image displayed on the display surface 51 by the display unit 210 high. The control unit 270 sets the luminance of the image displayed on the display surface 51 by the display unit 210 higher than the luminance of an image displayed on the display surface 51 by the display unit 210 when the distance is smaller than the first threshold.

For example, even when the display surface 51 is disposed near the room light and the contrast of the image displayed on the display surface 51 decreases, it is possible to suppress the decrease in the contrast of the image by setting the luminance of the image displayed on the display surface 51 high.

When the distance detected by the distance sensor 235 is equal to or larger than the second threshold, the control unit 270 sets the display on the display surface 51 of the tool image 20 used for the operation of the display apparatus to be hidden.

Therefore, in a scene in which the height of the display surface 51 from the setting surface is large and it is less likely that the tool image 20 is used, it is possible to erase the display of the tool image 20.

### Second Embodiment

A second embodiment of the invention is explained.

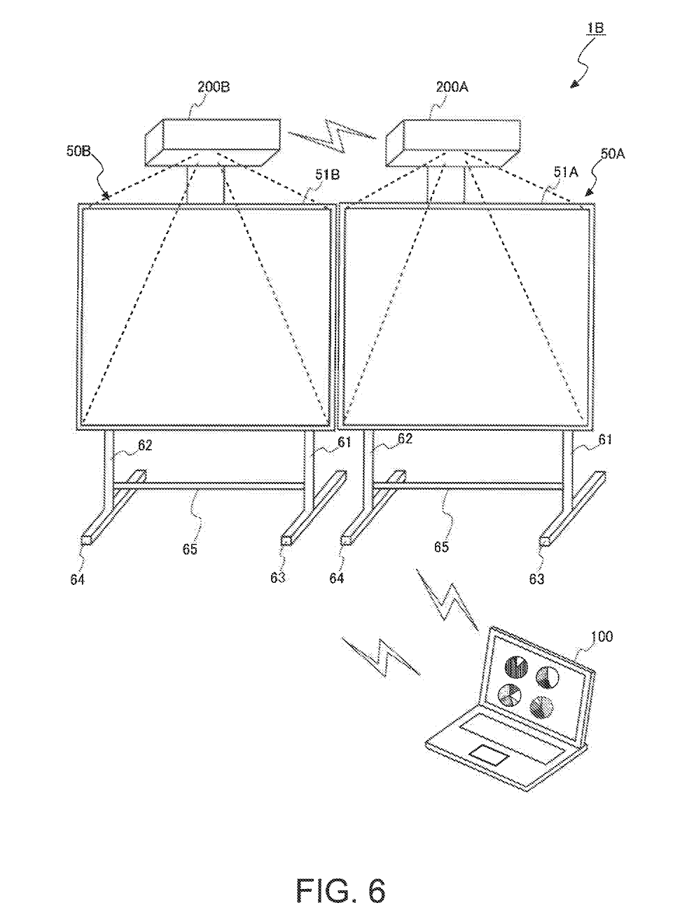

FIG. 6 is a configuration diagram showing a system configuration of a display system 1B in the second embodiment.

The display system 1B in this embodiment includes two screen boards 50A and 50B, two projectors 200A and 200B, and the image supply apparatus 100. The configuration of the projectors 200A and 200B is the same as the configuration of the projector 200 shown in FIG. 2. Illustration and detailed explanation of the configuration are omitted.

The projector 200A is fixed to the screen board 50A and displays a projected image on a display surface 51A of the screen board 50A. The projector 200B is fixed to the screen board 50B and displays a projected image on a display surface 51B of the screen board 50B.

In this embodiment, the projectors 200A and 200B and the image supply apparatus 100 are respectively connected to a wireless network such as a wireless LAN and configured to be capable of performing data communication each other. In this embodiment, image signals are transmitted to the projectors 200A and 200B by one image supply apparatus 100. However, the image supply apparatus 100 that supplies the image signal to the projector 200A and the image supply apparatus 100 that supplies the image signal to the projector 200B may be separately provided.

Control data is transmitted and received between the projector 200A and the projector 200B.

The screen board 50A and the screen board 50B are horizontally set side by side in a row such that the heights of the display surfaces 51A and 51B are aligned. For example, when the height of the display surface 51A of the screen board 50A is changed, the height of the display surface 51B of the screen board 50B is also changed to be aligned with the height of the display surface 51A.

In this embodiment, an image displayed on the display surface 51A by the projector 200A and an image displayed on the display surface 51B by the projector 200B are combined and displayed as one large screen image. This display form is called tiling display.

In order to perform the tiling display, the image supply apparatus 100 performs processing for dividing an original image, on which the large screen image is based, into partial images corresponding to the number (two) of the projectors 200. In this embodiment, the image supply apparatus 100 generates image data representing the partial image projected by the projector 200A and image data representing the partial image projected by the projector 200B.

The image supply apparatus 100 transmits, by radio, image signals including the image data representing the generated partial images respectively to the projectors 200A and 200B disposed in positions corresponding to the partial images.

The projector 200A receives the image signal from the image supply apparatus 100, extracts the image data representing the partial image from the received image signal, and processes the image data with the image processing unit 261. The projector 200A displays an image based on the processed image data on the display surface 51A. The projector 200B receives the image signal from the image supply apparatus 100, extracts the image data representing the partial image from the received image signal, and processes the image data with the image processing unit 261. The projector 200B displays an image based on the processed image data on the display surface 51B. Consequently, the image displayed on the display surface 51A and the image displayed on the display surface 51B are combined and displayed as one large screen image.

In this embodiment, the distance sensor 235 is mounted on either one of the projector 200A and the projector 200B. The distance sensor 235 measures the distance between the display surface 51A or 51B and the setting surface. In this embodiment, it is assumed that the distance sensor 235 is mounted on the projector 200A and the distance sensor 235 is not mounted on the projector 200B. In this embodiment, the projector 200A mounted with the distance sensor 235 operates as the “control device” in the aspect of the invention.

The control unit 270 (hereinafter referred to as control unit 270A) of the projector 200A detects the height from the floor surface to the display surface 51A on the basis of distance information measured by the distance sensor 235. The control unit 270A determines whether the detected height of the display surface 51A is changed.

When determining that the height of the display surface 51A is changed, the control unit 270A refers to the processing association table 257 (hereinafter referred to as processing association table 257A) stored in the storing unit 255 (hereinafter referred to as storing unit 255A) of the projector 200A. The control unit 270A determines, referring to the processing association table 257, whether a section to which the detected height of the display surface 51A belongs is changed. When the section to which the detected height of the display surface 51A belongs is changed, the control unit 270A acquires information concerning processing associated with the section from the processing association table 257A. The control unit 270A transmits the acquired information indicating the processing to the projector 200B. The control unit 270A controls the units of the projector 200A and executes the processing indicated by the acquired information.

In the second embodiment, the projector 200A detects the height of the display surface 51A from the setting surface and detects processing associated with the detected height. The projector 200A transmits information indicating the detected processing to the projector 200B and executes the detected processing. That is, the projector 200A functioning as the control device detects processing that the projector 200A causes the projector 200B to execute and transmits information indicating the detected processing to the projector 200B. When receiving the information indicating the processing from the projector 200A, a control unit 270B of the projector 200B controls the units of the projector 200B and executes the processing corresponding to the received information.

Consequently, in this embodiment, an effect same as the effect in the first embodiment explained above can be obtained. That is, a display form of an image displayed on the display surface 51A by the projector 200A and a display form of an image displayed on the display surface 51B by the projector 200B are changed to the same display form. Specifically, when the height of the display surfaces 51A and 51B is changed to a high position such as the section 4 or the section 5, the image displayed by the projector 200A and the image displayed by the projector 200B are changed to images having luminance higher by a value set in advance.

When the height of the display surfaces 51A and 51B is changed to a high position such as the section 4 or the section 5, the tool image 20 displayed on the display surface 51A or 51B by the projector 200A or 200B is set to be hidden.

The first and second embodiments are preferred embodiments of the invention. However, the invention is not limited to this. Various modified implementations are possible without departing from the spirit of the invention.

For example, in the first and second embodiments, the floor surface is set as the reference position and the distance from the floor surface to the projector 200 (200A) is measured. However, the invention is not limited to this. Another position may be set as the reference position. For example, a ceiling may be set as the reference position. That is, the distance sensor 235 is mounted on the lower surface side of the exterior housing of the projector 200 and the distance from the projector 200 (200A) to the ceiling is measured. When the height of the display surface 51 changes, the distance from the projector 200 (200A) to the ceiling also changes according to the height of the display surface 51. Therefore, a display form of an image displayed on the display surface 51 can also be changed on the basis of the distance to the ceiling measured by the distance sensor 235.

In the embodiments, as the light modulating unit 212 that modulates the light emitted by the light source, the configuration including the three transmissive liquid crystal panels corresponding to the colors of RGB is explained as the example. However, the invention is not limited to this. For example, the light modulating device 212 may be a configuration including three reflective liquid crystal panels. A system in which one liquid crystal panel and color wheels are combined may be used. Alternatively, the light modulating unit 212 may be configured by a system in which three digital mirror devices (DVDs) are used, a DMD system in which one digital mirror device and color wheels are combined, or the like. When only one liquid crystal panel or DMD is used as the light modulating unit 212, a member equivalent to a combination optical system such as a cross dichroic prism is unnecessary. Besides the liquid crystal panel and the DMD, a light modulating unit capable of modulating the light emitted by the light source can be adopted without a problem.

The functional units of the projector 200 shown in FIG. 2 indicate functional configurations. Specific implementation forms of the functional units are not particularly limited. That is, hardware individually corresponding to the functional units does not always need to be mounted. Naturally, it is also possible to adopt a configuration in which one processor executes computer programs to realize functions of a plurality of functional units. A part of the functions realized by software in the embodiments may be realized by hardware. Alternatively, a part of the functions realized by hardware in the embodiments may be realized by software. Besides, the specific detailed configurations of the other units of the projector 200 can also be optionally changed without departing from the spirit of the invention.

The processing units of the flowcharts of FIGS. 3 and 5 are divided according to main processing content in order to facilitate understanding of the processing by the control unit 270 of the projector 200. The invention is not limited by a way of division and names of the processing units. The processing by the control unit 270 can be divided into more processing units according to processing content and can be divided such that one processing unit includes more kinds of processing. The processing order of the flowcharts is not limited to the examples shown in the figures.

What is claimed is:

1. A display apparatus comprising:
a display unit configured to display an image on a display surface supported movably;
a detecting unit configured to detect a distance from a reference position set in advance to the display surface;
a storing unit configured to store information indicating processing executed by the display unit when the distance from the reference position to the display surface is a first distance; and
a control unit configured to cause the display unit to execute the processing in a case that the distance detected by the detecting unit changes from a second distance to the first distance.

2. The display apparatus according to claim 1, wherein, in the case that the distance detected by the detecting unit changes from the second distance to the first distance, the control unit changes a display form of the image displayed on the display surface by the display unit to a display form corresponding to the first distance.

3. The display apparatus according to claim 1, wherein
the display surface is supported by a supporting body to be capable of moving in a first direction and a second direction opposite to the first direction,
the display apparatus is fixed to the supporting body such that the distance to the display surface is constant even if the display surface is moved in the first direction or the second direction, and
the detecting unit sets, as the reference position, a setting surface on which the supporting body is set, measures a distance from the setting surface to the display apparatus, and detects a distance from the setting surface to the display surface on the basis of the measured distance.

4. The display apparatus according to claim 1, wherein
the storing unit stores, in association with a plurality of sections set in advance by dividing a movable range of the display surface, information indicating a plurality of kinds of processing executed by the display unit, and
the control unit specifies a section in which the display surface is located referring to the storing unit on the basis of the distance detected by the detecting unit and causes the display unit to execute processing associated with the specified section.

5. The display apparatus according to claim 4, further comprising a receiving unit configured to receive an input, wherein
the control unit causes the storing unit to store the information indicating the kinds of processing in association with the sections on the basis of the input received by the receiving unit.

6. The display apparatus according to claim 4, wherein, when determining that a state in which the distance detected by the detecting unit does not change continues, the control unit specifies a section in which the display surface is located and causes the display unit to execute processing associated with the specified section.

7. The display apparatus according to claim 1, wherein, when the distance detected by the detecting unit is equal to or larger than a first threshold, the control unit sets luminance of an image displayed on the display surface by the display unit higher than luminance of an image displayed on the display surface by the display unit when the distance is smaller than the first threshold.

8. The display apparatus according to claim 1, wherein, when the distance detected by the detecting unit is equal to or larger than a second threshold, the control unit sets display on the display surface of an image for operation used for operation of the display apparatus to be hidden.

9. A display system comprising:
a display apparatus configured to display an image on a display surface supported movably;
a detecting unit configured to detect a distance from a reference position set in advance to the display surface;
a storing unit configured to store information indicating processing executed by the display apparatus when the distance from the reference position to the display surface is a first distance; and
a control unit configured to cause the display apparatus to execute the processing in a case that the distance detected by the detecting unit changes from a second distance to the first distance.

10. A control method for a display apparatus that displays an image on a display surface supported movably, the control method comprising:
detecting a distance from a reference position set in advance to the display surface; and
executing, in a case that the detected distance changes from a second distance to a first distance, processing corresponding to the first distance.
